(19) United States
(12) Patent Application Publication
(10) Pub. No.: US 2025/0392475 A1
(43) Pub. Date: Dec. 25, 2025

(54) SENDER, RECEIVER AND METHOD FOR VERIFYING THE VALIDITY OF DATA TRANSMITTED OVER A TRANSMISSION CHANNEL

(71) Applicant: WAGO Verwaltungsgesellschaft mbH, Minden (DE)

(72) Inventor: Markus WEIDNER, Minden (DE)

(73) Assignee: WAGO Verwaltungsgesellschaft mbH, Minden (DE)

(21) Appl. No.: 19/249,283

(22) Filed: Jun. 25, 2025

(30) Foreign Application Priority Data
Jun. 25, 2024 (DE) 10 2024 117 825.6

(51) Int. Cl. H04L 9/32; H04L 9/08

(52) U.S. Cl. CPC H04L 9/3247; H04L 9/0825

(57) ABSTRACT

A sender, a receiver, and a method are provided for verifying the validity of data transmitted via a transmission channel, comprising the steps of generating first signature information on the basis of first data and a first key, augmenting the first signature information on the basis of second data and a second key. The first data is redundant with respect to the second data if the first and second data are valid. The first data or the second data and the augmented signature information is transmitted from a sender to a receiver via the transmission channel. The receiver verifies whether the augmented signature information was generated on the basis of the received data, the first key, and the second key.

This nonprovisional application claims priority under 35 U.S.C. § 119 (a) to German Patent Application No. 10 2024 117 825.6, which was filed in Germany on Jun. 25, 2024, and which is herein incorporated by reference.

### BACKGROUND OF THE INVENTION

### Field of the Invention

The present invention relates to a sender, a receiver, and a method for verifying the validity of data transmitted over a transmission channel.

### Description of the Background Art

Communication may be redundant, especially if safety-critical communication is involved. To this end, one or more transmission channels may be provided over which identical data packets may transmitted independently of one another.

### SUMMARY OF THE INVENTION

A method for verifying the validity, in particular the authenticity and/or correctness, of data transmitted via a transmission channel may comprise generating first signature information on the basis of first data and a first key, augmenting the first signature information on the basis of second data and a second key, wherein the first data is redundant with respect to the second data if the first and second data are valid, transmitting the first data or the second data and the augmented signature information from a sender to a receiver via the transmission channel, and verifying, by the receiver, whether the augmented signature information was generated on the basis of the received data, the first key, and the second key.

In this regard, the term “transmission channel”, may refer to a physical connection over one or more conductive media. Moreover, a transmission channel may be established based on a radio connection. Furthermore, the term “signature information”, may refer to a data structure which makes it possible to identify the owner of the signature and, potentially, to detect changes to the data that is provided with the signature. Moreover, the wording “augmenting the first signature information” may mean that the first signature information can be derived from the augmented signature information. For example, the augmented signature information may include the first signature information. The augmented signature information may be calculated on the basis of the first signature information, which allows for an indirect verification of the first signature information.

Furthermore, the term “key” may refer to data representing a substantially randomly generated string of characters. In addition, the wording that “the first data is redundant with respect to the second data”, may mean that the first and second data are identical, wherein it may be sufficient for the existence of redundancy within the meaning of the present invention if the first data can be derived from the second data. Furthermore, the wording “if the first and second data are valid” may mean that said condition is met if the first and second data are correct (i.e. not erroneous).

The receiver may further verify, using the second data and assuming that the first and second data are valid, whether the first signature information was generated on the basis of the first data and the first key. In the case of symmetric cryptography, the receiver may, for example, generate third signature information based on the second data and the first key and compare the first signature information with the third signature information. In the case of asymmetric cryptography, the receiver may decrypt the first signature information with a first verification key and then verify the decrypted first signature information.

Augmenting the first signature information on the basis of the second data and the second key may comprise generating second signature information based on the second data and the second key. The augmented signature information may comprise the first signature information and the second signature information. The receiver may use the received data to verify whether the second signature information was generated on the basis of the second data and the second key. In the case of symmetric cryptography, the receiver may, for example, generate fourth signature information on the basis of the received data and the second key and compare the second signature information with the fourth signature information. In the case of asymmetric cryptography, the receiver may decrypt the second signature information with a second verification key and then verify the decrypted second signature information.

Augmenting the first signature information on the basis of the second data and the second key may comprise generating the second signature information on the basis of the first signature information and the second key. The augmented signature information may, for example, be calculated over the second data and the first signature information. In the case of symmetric cryptography, the receiver may calculate the augmented signature information using the second data and the first signature information and compare it with the received extended signature information. In the case of asymmetric cryptography, the receiver may decrypt the augmented signature information with a verification key and then verify the decrypted augmented signature information.

The receiver may further verify whether data has been received from all members of a specific sender group, wherein the identity of a member of the group is authenticated on the basis of an augmented signature information.

A sender may comprise a first controller having a first memory configured to store a first key, and a second controller having a second memory configured to store a second key. The first controller may be configured to receive first data via a first communication channel and to generate first signature information on the basis of the first data and the first key, and to send the first signature information to the second controller. The second controller may be configured to receive second data via a second communication channel and to generate augmented signature information on the basis of the second data and the second key, wherein the first data may be redundant with respect to the second data (if the first and second data are valid). The second controller may be further configured to send the second data and the augmented signature information to a receiver. The second data and the augmented signature information may be sent to the receiver in one message via a single-channel connection.

The second controller may be further configured to generate the augmented signature information on the basis of the second data, the first signature information, and the second key. The augmented signature information may, for example, comprise the first signature information and second signature information. The second signature information may be calculated over the second data using the second key and then be appended to the first signature information. The augmented signature information may also be calculated over the second data and the first signature information which is appended to the second data, using the second key.

A receiver may comprise a first controller having a first memory configured to store a first verification key and a second verification key, and a second controller having a second memory configured to store the first verification key and the second verification key. The first controller may be configured to receive second data and augmented signature information and to verify the augmented signature information using the second data and to verify first signature information using the second data and the first verification key. The second controller may be configured to receive the second data and the augmented signature information and to verify the augmented signature information using the second data and the second verification key and to verify the first signature information using the second data and the first verification key.

The first signature information may be part of the augmented signature information and the first controller may be configured to determine the first signature information by decrypting the augmented signature information using the second verification key or the first controller may be configured to indirectly verify the first signature information by calculating the augmented signature information on the basis of the second data and the first and second verification keys.

The first signature information may be part of the augmented signature information and the second controller may be configured to determine the first signature information by decrypting the augmented signature information using the second verification key or the second controller may be configured to indirectly verify the first signature information by calculating the augmented signature information on the basis of the second data and the first and second verification keys.

If the verifications based on the first and second verification keys show that the received augmented signature information can be generated on the basis of the received second data and the corresponding first and second keys, the second data may be processed and/or forwarded.

The first controller and the second controller may be identical in their construction. If the receiver outputs over more than two channels, the receiver may comprise additional controllers of the same construction (wherein the number of controllers may match the number of channels).

Furthermore, it is understood that the features described in connection with the method may also be features of the sender and the receiver which carry out the steps of the method, and vice versa.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

Some of the foregoing aspects are further explained below in the detailed description based on embodiments with reference to drawings in which:

FIG. 1 shows a sender connected to a receiver via a transmission channel; and

FIG. 2 shows a flowchart of a method for verifying the validity of data transmitted over a transmission channel.

In the drawings, identical or functionally similar elements are identified by identical reference signs.

### DETAILED DESCRIPTION

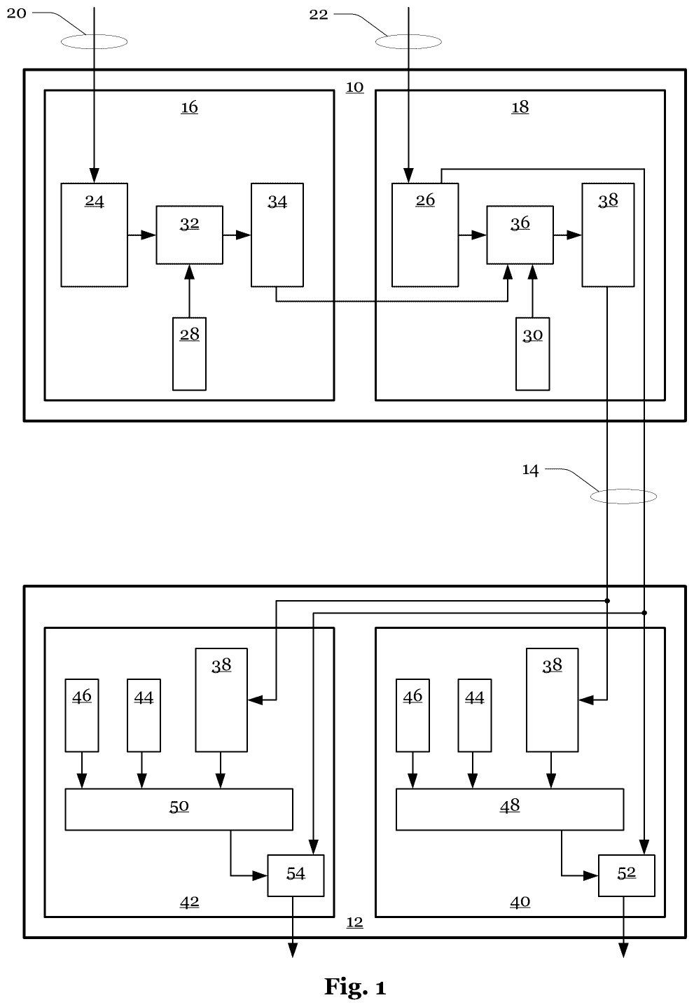

FIG. 1 shows sender 10 and receiver 12 which are connected to each other via (single) transmission channel 14. Sender 10 and receiver 12 may be safety-related or part of a safety-related system or process. Transmission channel 14 may be a wire line, an optical fiber, or a radio connection. Sender 10 comprises two controllers 16 and 18 which (in error-free operation) receive identical data 24 and 26 via two transmission channels 20 and 22 (or generate identical data 24 and 26 from, or in response to, information received via the two transmission channels 20 and 22). To transmit data over (insecure) transmission channel 14, sender 10 generates a message. The message may be safety-related. The message comprises a copy of data 24 and data 26 and cryptographic signature information 38. For generating signature information 38, both controllers 16 and 18 have their own individual cryptographic key 28 and 30, respectively.

To generate signature information 38, circuit 32 of controller 16 calculates first signature information 34 over data 24 using key 28:
signature information 34=encrypt (key 28; data 24)

Controller 16 sends signature information 34 (but not data 24) to controller 18. Controller 18 receives signature information 34 and circuit 36 of controller 18 may calculate signature information 38 over data 26 and signature 34 using key 30:
signature information 38=encrypt (key 30; data 26∥ signature information 34)

I.e., controller 18 may calculate signature information 38 from the concatenation of data 26 with signature information 34 which was calculated over data 24 using key 28. Alternatively, circuit 36 may calculate signature information S over data 26 using key 30 (signature information S=encrypt (key 30; data 26)) and append it to signature information 34. In this case, this would be:
signature information 38=signature information 34| signature information S

Sender 10 then sends a message with data 26 and augmented signature information 38 via transmission channel 14 to receiver 12. Within receiver 12, the message is forwarded to two controllers 40 and 42. Each of the controllers 40 and 42 comprises two verification keys 44 and 46, which are assigned to the generator key 28 and the generator key 30, respectively. The validity (i.e., the authenticity and correctness, wherein correctness can be understood to mean, for example, that the data 24 and 26 processed by the sender 10 is identical and that the data 26 received by the receiver 12 is unchanged) of the data 24 and 26 may thus be verified independently of one another by the circuits 48 and 50, respectively. The data 26 may then be processed and/or forwarded or discarded by the circuits 52 or 54 based on the result of the verification.

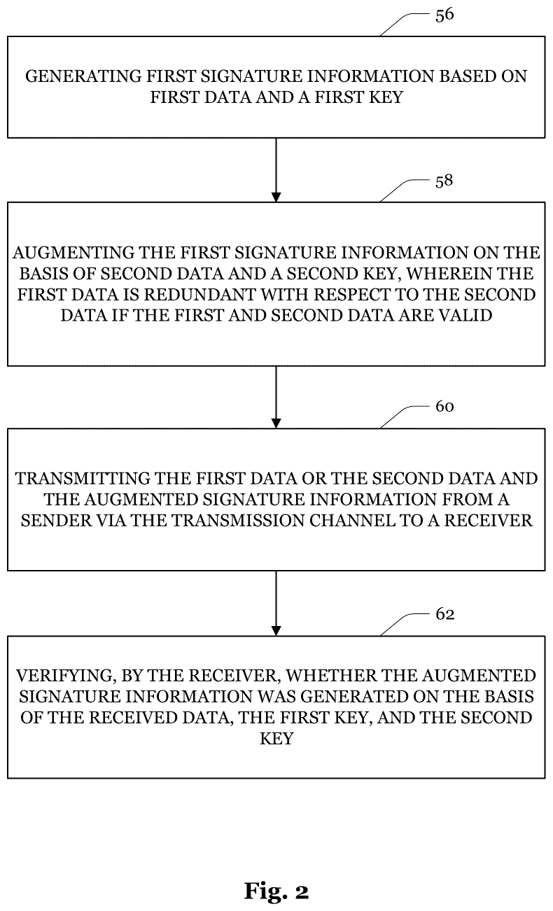

FIG. 2 shows a flowchart of a procedure for verifying the validity of data 26 transmitted via transmission channel 14. The method starts with step 56 of generating the first signature information 34 on the basis of the first data 24 and the first key 28. In step 58, the first signature information 34 is augmented on the basis of the second data 26 and the second key 30. In step 60, the first data 24 or the second data 26, and the augmented signature information 38 are transmitted from the sender 10 to the receiver 12 via the transmission channel 14. The method ends with step 62 of verifying, by the receiver 12, whether the augmented signature information 38 was generated on the basis of the received data 26, the first key 28, and the second key 30.

The procedure has the following advantages. The augmented signature information 38 attests to the identity of sender 10 or controllers 16 and 18. To this end, sender 10 and receiver 12 may be provided with the keys 28, 30, 44 and 46 from a trusted source via a trusted channel. The provision of keys 28, 30, 44 and 46 may be carried out, for example, as part of the configuration during commissioning.

The augmented signature information 38 may also be used to verify that all controllers 16 and 18 of the sender 10 have received or generated the same data 24 and 26, respectively. The augmented signature information 38 further attests that all controllers 16 and 18 of the sender 10 were involved in the generation of the transmitted message. This is because none of the controllers 16 and 18 of the sender 10 would be able to generate a valid message on its own.

The augmented signature information 38 may further be used to verify whether the transmitted data 26 and/or the augmented signature information 38 have been changed after their generation. In addition, the augmented signature information 38 can be kept compact by calculating the extended signature information 38 over the second data 26 and the first signature information 34 appended to the second data 26.

If using a symmetric cryptographic scheme, keys 28 and 44 and keys 30 and 46 may be identical. If using an asymmetric cryptographic scheme, keys 28 and 44 and keys 30 and 46 may be different.

The procedure, the sender 10, and the receiver 12 may be used to generate and/or transmit control data within the framework of a process which may be transitioned to a safe state from which no hazard arises. Since all possible transmission errors can be detected by the receiver, it is possible in such a case that process data are transmitted in a single channel via the potentially insecure communication channel 14. If the receiver-side verifications reveal an error, safe replacement values may be used instead of the corrupted process values, thus keeping the process in a safe state.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for verifying the validity, in particular the authenticity and/or correctness, of data transmitted via a transmission channel, the method comprising:
generating first signature information based on first data and a first key;
augmenting the first signature information on the basis of second data and a second key, the first data being redundant with respect to the second data if the first and second data are valid;
transmitting the first data or the second data and the augmented signature information from a sender via the transmission channel to a receiver; and
verifying, by the receiver, whether the augmented signature information was generated on the basis of the received data, the first key, and the second key.

2. The method according to claim 1, further comprising:
verifying, by the receiver, whether the first signature information was generated on the basis of the first data and the first key using the second data and assuming that the first and second data are valid,
wherein the augmented signature information comprises the first signature information.

3. The method according to claim 1, wherein augmenting the first signature information on the basis of the second data and the second key comprises generating second signature information based on the second data and the second key, and wherein the augmented signature information comprises the second signature information, and wherein the method further comprises:
verifying, by the receiver, whether the second signature information was generated on the basis of the second data and the second key, using the received data.

4. The method according to claim 3, further comprising:
generating, by the receiver, third signature information on the basis of the second data and the first key, wherein verifying whether the first signature information was generated based on the first data and the first key comprises comparing the first signature information and the third signature information; and
generating, by the receiver, fourth signature information on the basis of the second data and the second key, wherein verifying whether the second signature information was generated on the basis of the second data and the second key comprises comparing the second signature information and the fourth signature information.

5. The method according to claim 3, wherein verifying whether the first signature information is generated on the basis of the first data and the first key comprises decrypting the first signature information with a third key, and verifying whether the second signature information is generated on the basis of the second data and the second key comprises decrypting the second signature information with a fourth key.

6. The method according to claim 1, wherein augmenting the first signature information on the basis of the second data and the second key comprises generating the second signature information on the basis of the first signature information and the second key.

7. The method according to claim 1, further comprising:
verifying, by the receiver, whether data has been received from all members of a specific sender group, wherein an identity of a member of the group is authenticated on the basis of augmented signature information.

8. A sender comprising:
a first controller having a first memory configured to store a first key; and
a second controller having a second memory configured to store a second key,
wherein the first controller is configured to receive first data via a first communication channel and to generate first signature information on the basis of the first data and the first key and to send the first signature information to the second controller,
wherein the second controller is configured to receive second data via a second communication channel and to generate augmented signature information on the basis of the second data and the second key, and
wherein the first data is redundant with respect to the second data if the first and second data are valid, and to send the second data and the augmented signature information to a receiver.

9. The sender of claim 8, wherein the second controller is configured to generate the augmented signature information on the basis of the second data, the first signature information, and the second key.

10. A receiver comprising:
a first controller having a first memory configured to store a first verification key and a second verification key; and
a second controller having a second memory configured to store the first verification key and the second verification key,
wherein the first controller is configured to receive second data and augmented signature information and to verify the augmented signature information using the second data and the second verification key and to verify first signature information using the second data and the first verification key, and
wherein the second controller is configured to receive the second data and the augmented signature information and to verify the augmented signature information using the second data and the second verification key and to verify the first signature information using the second data and the first verification key.

11. The receiver of claim 10, wherein the first signature information is part of the augmented signature information, the first controller is configured to determine the first signature information by decrypting the augmented signature information using the second verification key or the first controller is configured to indirectly verify the first signature information by calculating the augmented signature information on the basis of the second data and the first and second verification keys, and wherein the first signature information is part of the augmented signature information, the second controller is configured to determine the first signature information by decrypting the augmented signature information using the second verification key or the second controller is configured to indirectly verify the first signature information by calculating the augmented signature information on the basis of the second data and the first and second verification keys.
